(19) United States
(12) Patent Application Publication
(10) Pub. No.: US 2006/0234549 A1
(43) Pub. Date: Oct. 19, 2006

(54) Conductive terminal for a power connector and its manufacturing method

(76) Inventors: Shi-Zheng Yang, Shanghai (CN); Yajun Wu, Singapore (SG); Zhi Bing Cheng, Ku Shan (CN)

Correspondence Address: MOLEX INCORPORATED, 2222 WELLINGTON COURT, LISLE, IL, 60532, US

(21) Appl. No.: 11/391,052

(22) Filed: Mar. 28, 2006

(30) Foreign Application Priority Data
Apr. 13, 2005 (CN) 200510065850.0

(51) Int. Cl. H01R 13/40

(52) U.S. Cl. 439/595

(57) ABSTRACT

This invention includes a conductive terminal for a power connector and its manufacturing method. The conductive terminal comprises: a base portion, a contact portion and a engagement portion. Said engagement portion is stamped so that it extends from the base portion over the contact portion with a free end thereof forming a engagement end. Said contact portion is a solid column-like body. Locking portions are provided on at least one side of said base portion to hold the conductive terminal in the dielectric housing of the power connector. The conductive terminal is directly formed by stamping without repeated bending, which decreases manufacture steps and reduces manufacture cost.

### FIELD OF THE INVENTION

This invention relates to a conductive terminal for a power connector and its manufacturing method and, particularly, to a central conductive terminal for a miniature power connector which interconnects a circuit board with mating electrical elements to supply power and its manufacturing method.

### BACKGROUND OF THE INVENTION

Power connectors are widely used in electronic products like cell phone charger jacks to transmit direct current. FIG. 1 herein shows a prior art power connector which includes a dielectric housing 40, a first conductive terminal 50 and a second conductive terminal 60 mounted inside the dielectric housing 40. The first conductive terminal 50 comprises a solid column-like central contact portion 51 designed to engage a terminal in a mating connector (not shown), block-shaped base portion 52 press fit into a first locking slot 41 of the dielectric housing 10, a connecting portion 53 connecting to the base portion 52, and a curved engagement portion 54 extending and bending upwardly from the connecting portion 53. A plurality of locking portions 55 which can be locked by the inner wall of the first locking slot 41 of the dielectric housing 40 are provided on at least one side of the base portion 52 to effectively lock the first conductive terminal 50 in the dielectric housing 10.

In operation, one end of the first conductive terminal 50 and one end of the second conductive terminal 60 engage with respective terminals on the mating connector while the other ends thereof are pressed into engagement with a conductive circuit on the circuit board to effect a electric transmission function. In the first conductive terminal 50 of the prior art power connector, the column-like contact portion is directly bent to form an engagement portion 54 which is pressed into engagement with a conductive circuit on the circuit board to reduce the contact resistance of the power connector and stabilize the current circuit.

The manufacture process of the first conductive terminal 50 in the prior art is shown in FIG. 2. In the first step 100a, a metal strip made from a material such as copper is stamped to create in the plane of the strip, the base portion 562, the central contact portion 51, and the engagement portion 54. In step 200a the central contact portion 51 is swaged to form the solid column-like central contact portion 51. The engagement portion 54 is bent repeatedly to form the connecting portion 53 and the engagement portion 54 in step 300a. Final finishing of the connecting portion 53, the engagement portion 54, and the base portion 52 occurs in step 400a which results in the prior art terminal shown in FIG. 1.

However, the manufacture of the first conductive terminal 50 described above which requires a repeated bending process will increase the cost of the metal material used and will make the manufacturing process more difficult thereby raising the total manufacturing cost.

As a result, there are many deficiencies in prior art power connectors although improvements have been made to enhance the stability of the first conductive terminal and simplify the manufacture process. The structure and manufacturing method of the first conductive terminal needs to be improved in the areas of quality, raising productivity, and reducing manufacturing costs.

### SUMMARY OF THE INVENTION

The object of this invention is to provide a conductive terminal held in the dielectric housing designed to interconnect the terminals of a power connector with terminals of a mating connector to enhance the stability of current transmission. The connector is provided with conductive terminals of a simple structure, which is easily manufactured with high quality, low manufacturing costs and which can provide higher contact forces.

Another object of this invention is to provide a manufacturing method of a conductive terminal for a power connector that decreases manufacture steps, simplifies the manufacture process, stabilizes the product quality and reduces manufacture cost.

The invention described and claimed herein achieves the above objects by providing a conductive terminal for a power connector that may be mounted in the dielectric housing of the power connector. The terminal comprises a base portion, a contact portion extending from one end of the base portion and a engagement portion extending from the base portion over the contact portion with its free end thereof forming a engagement end.

The engagement portion is formed by stamping. The contact portion is solid column-like body. Locking portions are provided on at least one side of the base portion to hold the conductive terminal within the dielectric housing of the power connector. The contact portion is preferably mounted in the dielectric housing of the power connector to electrically contact a terminal in a mating connector. The engagement end of the engagement portion is in electrical engagement with a circuit board. The conductive terminal is the central conductive terminal of the power connector.

This invention further includes a manufacturing method of a conductive terminal for a power connector in order to achieve the second object of this invention. The conductive terminal thereof comprises a base portion, contact portion and a engagement portion. This manufacturing method further includes the steps of:

1) Feeding and stamping the metal strip to form the locking portion and the base portion;

2) Stamping to form the contact portion and the engagement portion of the conductive terminal;

3) Swaging to form the solid cylindrical contact portion;

4) Breaking off the stamped conductive terminal from the metal strip.

The method according to the invention can further include a step of stamping a nick or side edge on the side of the metal strip before the step of feeding and stamping the metal strip to form the locking portion and the base portion. The method can include another step of stamping a guide hole on the metal strip before feeding and stamping the metal strip to form the locking portion and the base portion. The method can include an even further step stamping a breaking groove for conductive terminal on the metal strip is applied before feeding and stamping the metal strip to form the locking portion and the base portion.

This invention is an improvement because the engagement portion of the terminal is formed by directly cutting the metal without repeated bending of the engagement portion The repeated bending process in the prior art manufacture process of the conductive terminal is then omitted and the productivity is thus raised. Also a shape can be used in the subject invention which is more simple in design than the shape in the prior art terminal.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a fragmented perspective view of the prior art power connector;

FIG. 2 is a flow chart of the manufacture process of the conductive terminal of the prior art power connector;

FIG. 3 is a fragmented perspective view of the power connector applying the conductive terminal according to this invention;

FIG. 4 is a perspective view of the conductive terminal according to this invention mounted in a power connector;

FIG. 5 is a rear view of FIG. 4;

FIG. 6 is a front view of FIG. 4;

FIG. 7 is a top view of FIG. 4;

FIG. 8 is a flow chart of the manufacturing method of the conductive terminal of the power connector according to this invention; and

FIG. 9 is a perspective view of the manufacturing method of the conductive terminal of the power connector according to this invention.

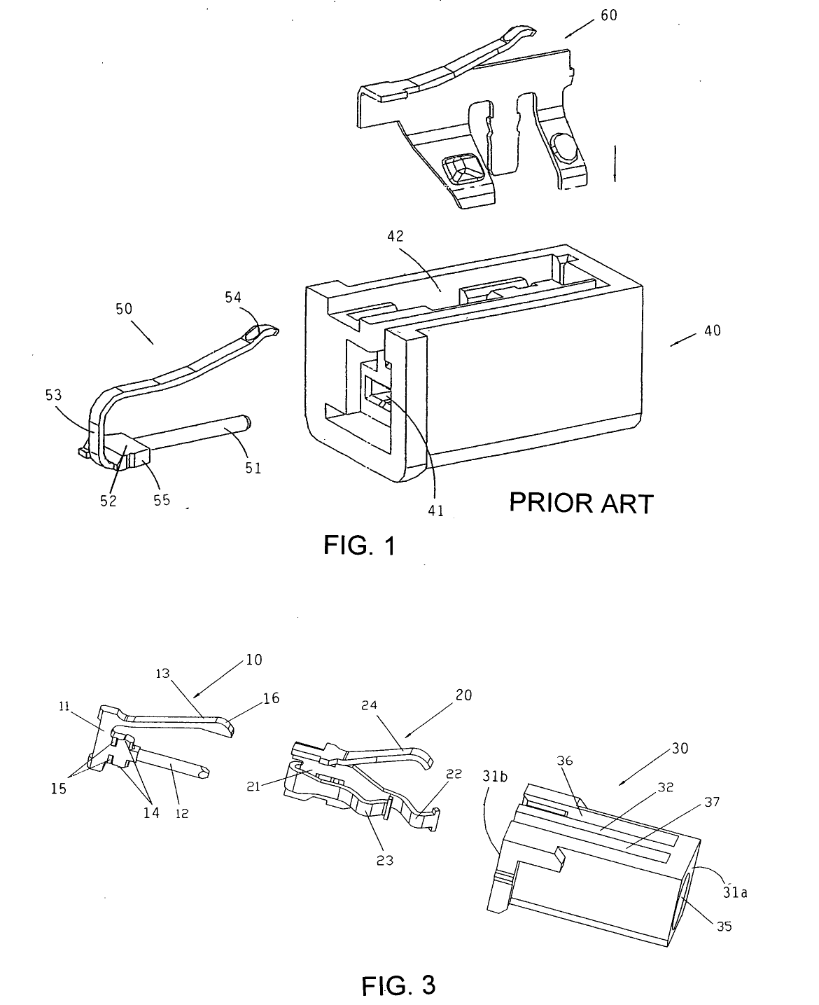

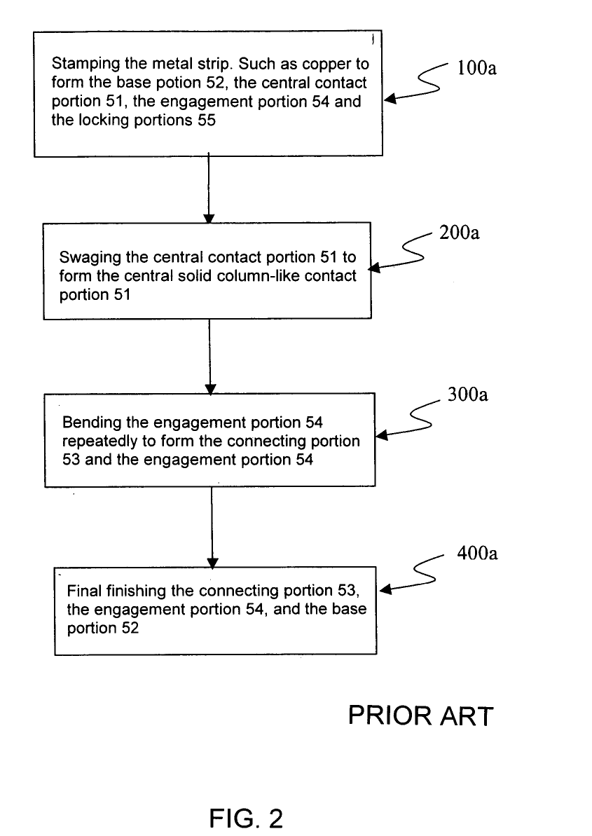

### DETAILED DESCRIPTION OF THE PREFERRED EMBODIMENT

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the FIGS. and in which:

FIG. 3 discloses the conductive terminal according to this invention embodied in a first conductive terminal 10 which functions as the central conductive terminal of the power connector. The conductive terminals 10 comprises a base portion 11, a contact portion 12, and a engagement portion 13. Locking portions 14 and 15 are disposed on two opposite sides of the base portion 11, respectively, wherein the locking portions 14 are projecting teeth while the locking portions 15 are recessed grooves. The first conductive terminal 10 can be firmly held in the dielectric housing of the power connector with the aid of the above locking portions. The contact portion 12 is of a solid column-like body extending forwardly from the front-end of the base portion 11 and formed by stamping and swaging. The engagement portion 13 is formed by stamping and extends forwardly from the upper end of the base portion 11 over the contact portion 12 with its free end thereof forming an engagement end 16.

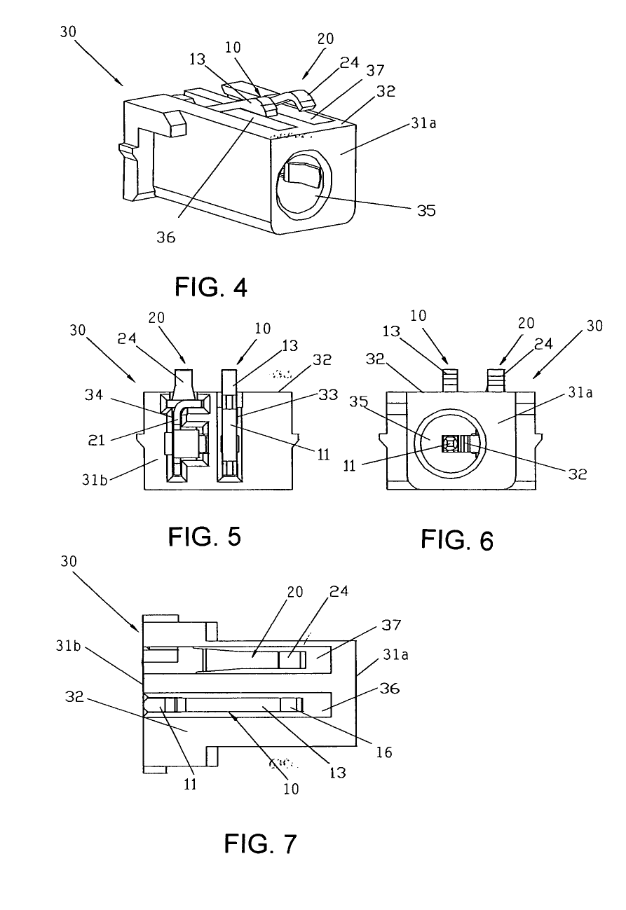

FIGS. 3-7 are views of the conductive terminal 10 according to this invention mounted in the power connector housing 30. The power connector includes a generally rectangular dielectric housing 30 with a first conductive terminal 10 and a second conductive terminal 20 mounted inside the dielectric housing 30. The dielectric housing 30 comprises a mating face 31a, a rear end face 31b on the side opposite the mating face 31a, and a mounting face 32. A first mounting passage 33 and a second mounting passage 34 are provided in the interior of the dielectric housing 30. A mating hole 35 on the mating face 31a communicates with the first and second mounting passages 33 and 34. Grooves 36, 37 is formed on the mounting face 32 extending from the rear end face 31b partially towards the mating face 31a, wherein the groove 36 communicates with the first mounting passage 33 on the rear end face 31b.

The first conductive terminal 10 is made of a metal strip, for example copper, by stamping. The first conductive terminal 10 is press fit into the first mounting passage 33 from the rear end face 31b of the dielectric housing 30. The base portion 11 and contact portion 12 extend into the first mounting passage 33. The locking portions 14 of a hook structure are held in the corresponding position on the sidewall of the passage and the locking portions 15 of a groove structure engage with the corresponding projection (not shown) on the side wall of the passage. The contact portion 12 is in electrical engagement with terminals in a mating plug connector (not shown). The engagement portion 13 of the first conductive terminal 10 is located in the mounting groove 36 on the mounting face 32 and extends out of the dielectric housing 30 with its engagement end 16 in electrical engagement with a circuit board (not shown) press-fitted whereon.

The second conductive terminal 20 is formed from a metal strip by stamping and bending, which is also press fit into the second mounting passage 34 from the rear end face 31b of the dielectric housing 30. The second conductive terminal 20 comprises a body 21, a first contact portion 22 extending forwardly from the front end of the base body 21, a second contact portion 23 extending forwardly and bending back to itself from the rear end of the base body 21 and a first engagement portion 24 extending upwardly and curved from the upper end of the base body 21. The base body 21, the first contact portion 22, and the second contact portion 23 extend into the second mounting passage 34 of the dielectric housing 30. The engagement portion 24 is located in the groove 37 on the mounting face 32 of the dielectric housing 30 and extends out of the dielectric housing 30, for being in electrical contact with a circuit board (not shown) press-fitted whereupon.

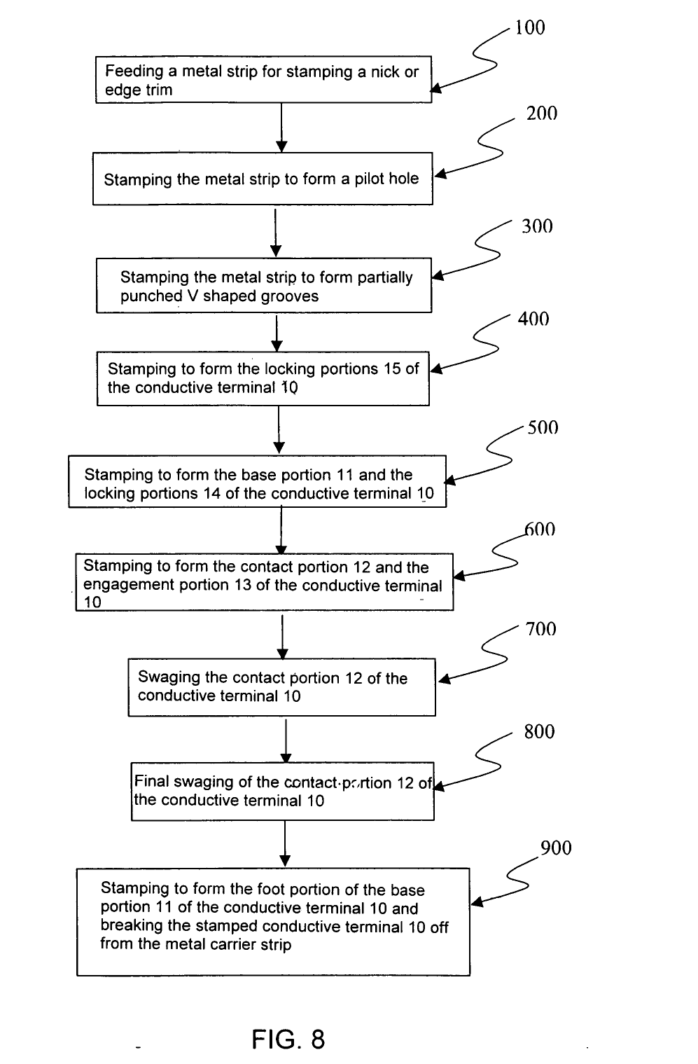

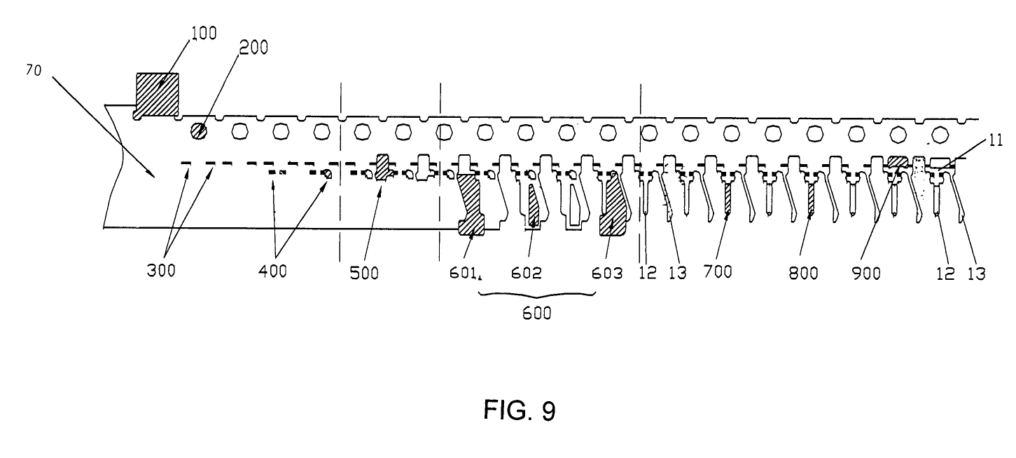

FIGS. 8 and 9 show the manufacturing method of the first conductive terminal 10 of the power connector. In step 100, a metal strip, which can be made of copper, is fed to stamp punch a nick or edge trim on one side of the strip for stress-relief. In step 200, the metal strip is stamped to form a pilot which will be used for feeding the strip evenly through the stamping machine. In step 300, a scored V groove is partially punched in portions of the strip which will be used at a later time to break the final formed terminal from the carrier strip. In step 400, the metal strip is stamped to form the locking portions 15 of the first conductive terminal 10. In step 500, the metal strip is stamped again to begin the formation of the base portion 11 and the hook-shaped locking portions 14 of the conductive terminal 10.

In step 600, the metal strip is stamped to form the engagement portion 13 and to begin to form the contact portion 12 of the conductive terminal 10. The left side of the contact portion 12 and the right side of the engagement portion 13 are stamped at step 601. The right side of the contact portion 12 and the left side of the engagement portion 13 are stamped at step 602. The final profile of engagement portion 13 and a rough cut of contact portion 12 is stamped at step 603.

The stamped contact portion 12 of the conductive terminal 10 is initially swaged in step 700. The second swaging operation occurs at step 800 to meet the final machining requirements. At step 900, the foot portion of base portion 11 of the conductive terminal 10 is stamped and then conductive terminal 10 can be broken off the metal carrier strip. In the alternative the contact portion 13 can be finished according to final product specifications as for example moving the carrier strip with the terminals 10 still attached into a plating bath

Because the engagement portion 13 of the first conductive terminal 10 is stamped without the repeated curving process as required in the formation of the connecting portion 53 and the engagement portion 54 in the prior art manufacture process, the product quality is improved while productivity is increased with a decrease in manufacturing costs.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A conductive terminal for a power connector which is mountable in a dielectric housing of the power connector, comprising: a base portion, a contact portion and an engagement portion extending from different ends of the base portion; said engagement portion stamped to form a structure extending from the base portion over the contact portion with a free end thereof forming an engagement end.

2. The conductive terminal for a power connector in claim 1, wherein said contact portion is configured into a solid column-like body.

3. The conductive terminal for a power connector in claim 1, wherein locking portions are provided on at least one side of the base portion to hold the conductive terminal within the dielectric housing of the power connector.

4. The conductive terminal for a power connector in claim 1 wherein said contact portion is received in the dielectric housing of the power connector to electrically engage a terminal from a mating connector.

5. The conductive terminal for a power connector in claim 1 wherein said engagement end of the engagement portion is designed to be in electrical engagement with a conductive circuit on a circuit board.

6. The conductive terminal for a power connector in claim 1 wherein said conductive terminal is a central conductive terminal of the power connector.

7. A manufacturing method of a conductive terminal for a power connector, the conductive terminal thereof comprising a base portion, a contact portion and a engagement portion, said method includes the steps of:
a) feeding and stamping a metal strip to form the locking portion and the base portion;
b) stamping to form the contact portion and the engagement portion of the conductive terminal;
c) swaging the contact portion; and
d) breaking off the stamped conductive terminal from the metal strip.

8. The manufacturing method of a conductive terminal for a power connector in claim 7, further including the step of stamping a foot portion in a bottom of the base portion of the conductive terminal after swaging the contact portion in step c.

9. The manufacturing method of a conductive terminal for a power connector in claim 7, further including the step of stamping to form the contact portion before the step of stamping to form the engagement portion in step b.

10. The manufacturing method of a conductive terminal for a power connector in claim 7, further including the step of stamping a nick on the side of the metal strip before the step of feeding and stamping the metal strip to form the locking portion and the base portion in step a.

11. The manufacturing method of a conductive terminal for a power connector in claim 7, further including the step of stamping a pilot hole on the metal strip before the step of feeding and stamping the metal strip to form the locking portion and the base portion in step a.

12. The manufacturing method of a conductive terminal for a power connector in claim 7, further including the step of stamping a partially punched V shaped groove before the step of feeding and stamping the metal strip to form the locking portion and the base portion in step a.

13. A manufacturing method of a conductive terminal for a power connector, the conductive terminal thereof comprising a base portion, a contact portion and a engagement portion, said method includes the steps of:
a) feeding and stamping a nick on the side of the metal strip;
b) stamping a pilot hole on the metal strip;
c) stamping a partially punched V shaped groove;
d) stamping a metal strip to form the locking portion and the base portion;
e) stamping to form the contact portion and the engagement portion of the conductive terminal;
f) swaging the contact portion;
g) stamping a foot portion in a bottom of the base portion of the conductive terminal after swaging the contact portion; and
h) breaking off the stamped conductive terminal from the metal strip.
